(19) United States
(12) Patent Application Publication
(10) Pub. No.: US 2007/0106050 A1
(43) Pub. Date: May 10, 2007

(54) Crosslinked poly(arylene ether) composition, method, and article

(76) Inventors: Alex Dimitri Sokolowski, Albany, NY (US); Scott Michael Fisher, Delmar, NY (US); Vijay Mhetar, Slingerlands, NY (US)

Correspondence Address: CANTOR COLBURN, LLP, 55 GRIFFIN ROAD SOUTH, BLOOMFIELD, CT, 06002, US

(21) Appl. No.: 11/269,322

(22) Filed: Nov. 8, 2005

(51) Int. Cl. C08G 61/02

(52) U.S. Cl. 528/86

(57) ABSTRACT

A crosslinked poly(arylene ether) is described, along with a method for its formation and an article including it. The crosslinked poly(arylene ether) is prepared by a method that includes forming a grafted poly(arylene ether) and reacting the grafted poly(arylene ether) with water to form a crosslinked poly(arylene ether). The grafted poly(arylene ether) is formed by reacting an uncrosslinked poly(arylene ether) with a crosslinking agent having the structure 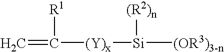
wherein R¹ is hydrogen or methyl; R² is C₁-C₈ hydrocarbyl; R³ is C₁-C₄ alkyl or C₂-C₆ alkoxyalkyl; n is 0, 1, or 2; x is 0 or 1; and Y is selected from
—R⁵—, —O—R⁵—, —C(O)—R⁵—, —C(O)—X—R⁵—, and —X—C(O)—R⁵—
wherein R⁵ is C₁-C₁₂ hydrocarbylene, and X is O, S, or NR⁶, wherein R⁶ is hydrogen or C₁ -C₁₂ hydrocarbyl.

### BACKGROUND OF THE INVENTION

Poly(arylene ether) resins and their blends with polystyrene or polyamide resins are widely used for their heat resistance, and balance of stiffness, impact strength, and tensile properties. The inherent heat resistance of poly(arylene ether) resins has been improved, for example, by varying the structure of the monomers from which they are synthesized. See, for example, U.S. Pat. No. 4,011,200 to Yonemitsu et al. The inherent flame retardancy of poly(arylene ether) resins has been improved, for example, by the addition of particular non-halogenated, phosphate ester flame retardants. See, for example, U.S. Pat. No. 5,294,654 to Hellstern-Bumell et al. Water absorption by blends of poly(arylene ether) and polyamides has been reduced, for example, by incorporating particular phenolic compounds. See, for example, U.S. Pat. No. 5,166,246 to Gallucci et al. The chemical resistance of poly(arylene ether) resins has been improved by blending with semicrystalline polyolefins and polystyrenes. See, for example, U.S. Pat. No. 6,849,695 to Sato. Notwithstanding these improvements, there remains a need for poly(arylene ether) resins with increased heat resistance, flame retardancy, and chemical resistance, and decreased water absorption. In particular, there is a desire to improve such properties without adding substantial amounts of other components to the poly(arylene ether) resin.

### BRIEF DESCRIPTION OF THE INVENTION

The above-described and other drawbacks are alleviated by a siloxane crosslinked poly(arylene ether). One embodiment is a crosslinked poly(arylene ether) comprises a crosslink unit having the structure 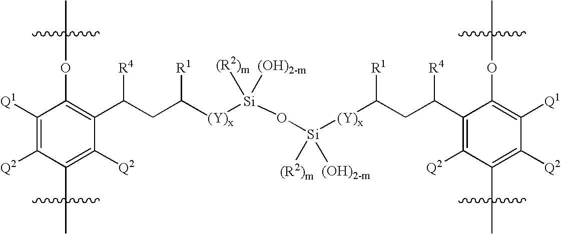
wherein each occurrence of R¹ is independently hydrogen or methyl; each occurrence of R² is independently C₁-C₈ hydrocarbyl; each occurrence of m is independently 0, 1, or 2; each occurrence of R⁴ is independently hydrogen or C₁-C₁₁ hydrocarbyl; each occurrence of Q¹ is independently halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms; each occurrence of Q² is independently hydrogen, halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms; each occurrence of x is independently 0 or 1; and each occurrence of Y is independently selected from
—R⁵—, —O—R⁵—, —C(O)—R⁵—, —C(O)—X—R⁵—, and —X—C(O)—R⁵—
wherein R⁵ is C₁-C₁₂ hydrocarbylene, and X is 0, S, or NR⁶, wherein R⁶ is hydrogen or C₁-C₁₂ hydrocarbyl.

Another embodiment is a crosslinked poly(arylene ether), prepared by a method, comprising: forming a grafted poly(arylene ether) by reacting an uncrosslinked poly(arylene ether) with a crosslinking agent having the structure 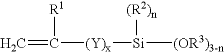
wherein R¹ is hydrogen or methyl; R² is C₁-C₈ hydrocarbyl; R³ is C₁-C₄ alkyl or C₂-C₆ alkoxyalkyl; n is 0, 1, or 2; x is 0 or 1; and Y is selected from
—R⁵—, —O—R⁵—, —C(O)—R⁵—, —C(O)—X—R⁵—, and —X—C(O)—R⁵—
wherein R⁵ is C₁-C₁₂ hydrocarbylene, and X is 0, S, or NR⁶, wherein R⁶ is hydrogen or C₁-C₁₂ hydrocarbyl; and reacting the grafted poly(arylene ether) with water to form a crosslinked poly(arylene ether).

Another embodiment is a method of forming a grafted poly(arylene ether), comprising: reacting an uncrosslinked poly(arylene ether) with a crosslinking agent having the structure 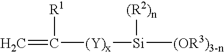
wherein R¹ is hydrogen or methyl; R² is C₁-C₈ hydrocarbyl; R³ is C₁-C₄ alkyl or C₂-C₆ alkoxyalkyl; n is 0, 1, or 2; x is 0 or 1; and Y is selected from
—R⁵—, —O—R⁵—, —C(O)—R⁵—, —C(O)—X—R⁵—, and —X—C(O)—R⁵—
wherein R⁵ is C₁-C₁₂ hydrocarbylene, and X is O, S, or NR⁶, wherein R⁶ is hydrogen or C₁-C₁₂ hydrocarbyl; and reacting the grafted poly(arylene ether) with water to form a crosslinked poly(arylene ether).

These and other embodiments, including a composition comprising the crosslinked poly(arylene ether), and an article comprising such a composition, are described in detail below.

### DETAILED DESCRIPTION OF THE INVENTION

One embodiment is a crosslinked poly(arylene ether) comprising a crosslink unit having the structure 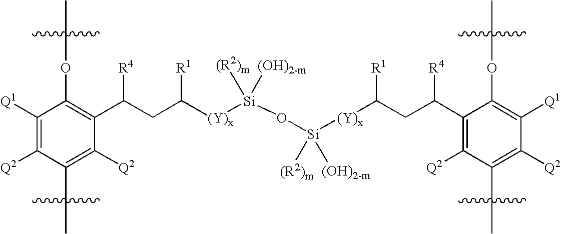
wherein each occurrence of R¹ is independently hydrogen or methyl; each occurrence of R² is independently C₁-C8 hydrocarbyl; each occurrence of m is independently 0, 1, or 2; each occurrence of R⁴ is independently hydrogen or C₁-C₁₁ hydrocarbyl; each occurrence of Q¹ is independently halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms; each occurrence of Q² is independently hydrogen, halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms; each occurrence of x is independently 0 or 1; and each occurrence of Y is independently selected from
—R⁵—, —O—R⁵—, —C(O)—R⁵—, —C(O)—X—R⁵—, and —X—C(O)—R⁵—
wherein R⁵ is C₁-C₁₂ hydrocarbylene, and X is O, S, or NR⁶, wherein R⁶ is hydrogen or C₁-C₁₂ hydrocarbyl. As used herein, the term “hydrocarbyl”, whether used by itself, or as a prefix, suffix, or fragment of another term, refers to a residue that contains only carbon and hydrogen. The residue may be aliphatic or aromatic, straight-chain, cyclic, bicyclic, branched, saturated, or unsaturated. It may also contain combinations of aliphatic, aromatic, straight chain, cyclic, bicyclic, branched, saturated, and unsaturated hydrocarbon moieties. In the structures specified above for the divalent group Y, it will be understood that the left end of each structure is bound to the carbon atom bearing R¹, and the right end of each structure is bound to the silicon atom adjacent to Y. For example, when each x is 1 and each Y has the structure —X—C(O)—R⁵ —, the crosslink unit has the structure 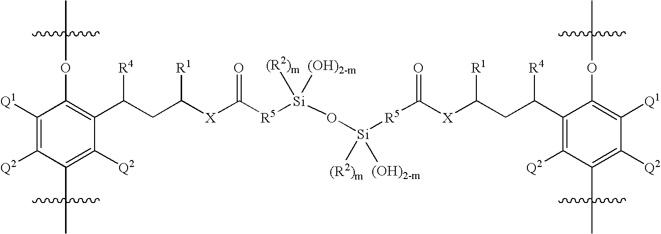
wherein R¹, R², R⁴, R⁵, Q¹, Q², X and m are defined as above.

In one embodiment, each occurrence of Q¹ is independently halogen or C₁-C₁₁ alkyl; and each occurrence of Q² is independently hydrogen, halogen, or C₁-C₁₁ alkyl. In another embodiment, each occurrence of R⁴ is hydrogen, each occurrence of Q¹ is methyl, and each occurrence of Q² is independently hydrogen or methyl. In another embodiment, each occurrence of R¹ is hydrogen, and each occurrence of m and x is zero.

In addition to the crosslink unit described above, the crosslinked poly(arylene ether) may comprise uncrosslinked poly(arylene ether) units. Thus, the crosslinked poly(arylene ether) may comprise a plurality of uncrosslinked units having the structure 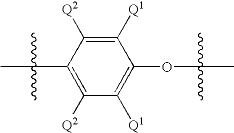
wherein each occurrence of Q¹ is independently halogen, halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms; and each occurrence of Q² is independently hydrogen, halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms.

In one embodiment, the crosslinked poly(arylene ether), comprises a crosslink unit having the structure 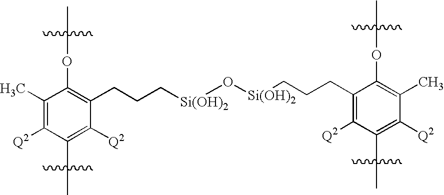
wherein each occurrence of Q² is independently hydrogen or methyl. In one embodiment, each Q² is hydrogen.

The crosslinked poly(arylene ether) may be prepared by a method comprising reacting an uncrosslinked poly(arylene ether) with a silane crosslinking agent to form a silane-grafted poly(arylene ether), and reacting the silane-grafted poly(arylene ether) with water to form the crosslinked poly(arylene ether). Thus, one embodiment is a crosslinked poly(arylene ether), prepared by a method, comprising: forming a grafted poly(arylene ether) by reacting an uncrosslinked poly(arylene ether) with a crosslinking agent having the structure 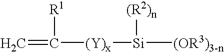
wherein R¹ is hydrogen or methyl; R² is C₁-C₈ hydrocarbyl; R³ is C₁-C₄ alkyl or C₂-C₆ alkoxyalkyl; n is 0, 1, or 2; x is 0 or 1; and Y is selected from
—R⁵—, —O—R⁵—, —C(O)—R⁵—, —C(O)—X—R⁵—, and —X—C(O)—R⁵—
wherein R⁵ is C₁-C₁₂ hydrocarbylene, and X is O, S, or NR⁶, wherein R⁶ is hydrogen or C₁-C₁₂ hydrocarbyl; and reacting the grafted poly(arylene ether) with water to form a crosslinked poly(arylene ether).

The uncrosslinked poly(arylene ether) comprises a plurality of repeating units having the structure 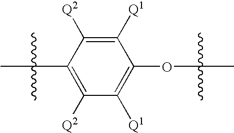
wherein each occurrence of Q¹ is independently halogen, halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms; and each occurrence of Q² is independently hydrogen, halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms. In one embodiment, the uncrosslinked poly(arylene ether) comprises repeating units having the structure above, each occurrence of Q¹ is independently halogen, or C₁-C₁₁ alkyl; and each occurrence of Q2 is independently hydrogen, halogen, or C₁-₁₁ alkyl. In another embodiment, each occurrence of Q¹ is methyl; and each occurrence of Q² is independently hydrogen or methyl.

Poly(arylene ether) ethers having a wide variety of molecular weights and intrinsic viscosities may be used as the uncrosslinked poly(arylene ether). For example, the uncrosslinked poly(arylene ether) may have an intrinsic viscosity of about 0.06 to about 0.6 deciliters per gram (dL/g) at 25° C. in chloroform. Within this range, the intrinsic viscosity may be at least about 0.1 dL/g, or at least about 0.2 dL/g, or at least about 0.3 dL/g. Also within this range, the intrinsic viscosity may be up to about 0.5 dL/g, or up to about 0.4 dL/g.

As noted above, the crosslinking agent has the structure 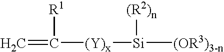
wherein R¹ is hydrogen or methyl; R2 is C₁-C₈ hydrocarbyl; R³ is C₁-C₄ alkyl or C₂-C₆ alkoxyalkyl; n is 0, 1, or 2; x is 0 or 1; and Y is selected from
—R⁵—, —O—R⁵—, —C(O)—R⁵—, —C(O)—X—R⁵—, and —X—C(O)—R⁵—
wherein R⁵ is C₁-C₁₂ hydrocarbylene, and X is O, S, or NR⁶, wherein R⁶ is hydrogen or C₁-C₁₂ hydrocarbyl. In one embodiment, x and n are zero, and R¹ is hydrogen. In one embodiment, x and n are zero, R¹ is hydrogen, and R³ is ethyl. In one embodiment, x is 1, Y is —C(O)—X—R⁵— wherein X is 0 and R⁵ is trimethylene (i.e., —CH₂CH₂CH₂—), n is zero, R¹ is hydrogen, and R³ is ethyl. Suitable crosslinking agents include, for example, vinyltrimethoxysilane, vinyltriethoxysilane, vinyltris(2-methoxyethoxy)silane, vinylmethyldimethoxysilane, vinylmethyldiethoxysilane, (3-methacryloxypropyl)triethoxysilane, (3-methacryloxypropyl)trimethoxysilane, (3-acryloxypropyl)triethoxysilane, and combinations thereof.

In the reaction of the uncrosslinked poly(arylene ether) with the crosslinking agent, the crosslinking agent is generally used in an amount of about 0.05 to about 20 parts by weight per 100 parts by weight of the uncrosslinked poly(arylene ether). Within this range, the crosslinking agent amount may be at least about 0.1 part by weight, or at least about 0.5 part by weight, or at least about 1 part by weight. Also within this range, the crosslinking agent amount may be up to about 10 parts by weight, or up to about 5 parts by weight. The reaction of the uncrosslinked poly(arylene ether) with the crosslinking agent may be conducted in solution. For example, the reaction may be conducted in a solvent for the uncrosslinked poly(arylene ether), such as toluene or chloroform, at a temperature sufficient to form free radicals on the poly(arylene ether). Alternatively, the reaction may take place in the absence of solvent by melt kneading the uncrosslinked poly(arylene ether) and the crosslinking agent. In this embodiment, melt kneading is preferably conducted at a temperature about 20 to about 80° C. greater than the glass transition temperature of the uncrosslinked poly(arylene ether). Apparatus suitable for preparing thermoplastic blends via melt kneading includes, for example, a two-roll mill, a Banbury mixer, and a single-screw or twin-screw extruder.

The reaction of the uncrosslinked poly(arylene ether) with the crosslinking agent may, optionally, be conducted in the presence of a radical initiator. Radical initiators generally include compounds capable of generating free radicals at the reaction temperature of the poly(arylene ether) and the crosslinking agent. Suitable radical initiators include peroxy compounds. Examples of useful peroxy initiators include, for example, benzoyl peroxide, dicumyl peroxide, methyl ethyl ketone peroxide, lauryl peroxide, cyclohexanone peroxide, t-butyl hydroperoxide, t-butyl benzene hydroperoxide, 1,1,3,3-tetramethylbutyl hydroperoxide, t-butyl peroctoate, 2,5-dimethylhexane-2,5-dihydroperoxide, 2,5-dimethyl-2,5-di(t-butylperoxy)hexane, 2,5-dimethyl-2,5-di(t-butylperoxy)-hex-3-yne, di-t-butylperoxide, di-t-amyl peroxide, t-butyl cumyl peroxide, alpha,alpha′-bis(t-butylperoxy-m-isopropyl)benzene, di(t-butylperoxy)isophthalate, t-butylperoxybenzoate, 2,2-bis(t-butylperoxy)butane, 2,2-bis(t-butylperoxy)octane, 2,5-dimethyl-2,5-di(benzoylperoxy)hexane, di(trimethylsilyl)peroxide, trimethylsilylphenyltriphenylsilyl peroxide, 1,1-bis(t-butylperoxy)-3,3,5-trimethylcyclohexane, 2,2-bis(t-butylperoxy)butane, t-amyl peroxy benzoate, methyl ethyl ketone peroxide, and the like, and combinations thereof.

By adjusting the amount of crosslinking agent and the amount, if any, of radical initiator, it is possible to control the number of grafts per poly(arylene ether) chain. For example the grafted poly(arylene ether) may comprise about 0.2 to about 2.5 silyl grafts per poly(arylene ether) chain.

The method includes reacting the grafted poly(arylene ether) with water to form the crosslinked poly(arylene ether). In one embodiment, the grafted poly(arylene ether) is reacted with water at a temperature of about 85 to about 275° C. Within this range, the reaction temperature may be at least about 100° C., or at least about 185° C. Also within this range, the reaction temperature may be up to about 240° C., or up to about 230° C. Reaction times will vary according to factors including the physical form of the grafted poly(arylene ether), the reaction temperature, and the reaction water vapor pressure, but they are generally about 10 seconds to about 10 minutes. In another embodiment, the grafted poly(arylene ether) is reacted with water simply by exposing the grafted poly(arylene ether) to air. Obviously, this embodiment depends on the presence of water vapor in the air. This embodiment is most effective in the presence of one or more of the crosslinking catalysts described below.

In one embodiment, reacting the grafted poly(arylene ether) with water is conducted in the presence of a crosslinking catalyst. Suitable catalysts include, for example, dibutyl tin dilaurate, dibutyl tin diacetate, dibutyl tin laurate acetate, dibutyl tin dioctoate, dioctyl tin dilaurate, dioctyl tin dioctoate, bis(2-ethylhexanoate) tin, bis(neodecanoate)tin, stannous octoate, stannous acetate, dibutyl tin bis(acetylacetonate), lead naphthenate, cobalt naphthenate, zinc octoate, tetrabutyl titanate, tetranonyl titanate, bis(acetylacetonyl)dipropyltitanate, and the like, and combinations thereof. The catalyst may be used in an amount of about 10 to about 300 parts by weight per million parts by weight of the grafted poly(arylene ether). The crosslinking catalyst may be blended with the grafted poly(arylene ether) prior to or during its reaction with water.

In one embodiment, the grafted poly(arylene ether) is sheet extruded prior to reaction with water. Sheet extrusion may be performed as part of formation of the grafted poly(arylene ether) (e.g., as the grafted poly(arylene ether) exits an extruder in which it was formed by melt kneading the poly(arylene ether) and the crosslinking agent). Alternatively, sheet extrusion may occur as a separate step (e.g., after pelletizing the grafted poly(arylene ether), it may be remelted and sheet extruded). Apparatus and procedures for sheet extrusion of poly(arylene ether) resin compositions are described, for example, in Japanese Patent Application Publication Nos. JP 2000-301593 A to Moritomi, JP 10-166511 A to Ozeki, and JP 08-118494 A to Nabeta et al.

In one embodiment, the grafted poly(arylene ether) is solvent cast into a film prior to reaction with water. Solvents known to dissolve uncrosslinked poly(arylene ether) are generally suitable for solvent casting. Such solvents include, for example, dichloromethane, chloroform, toluene, xylenes, benzene, chlorinated benzenes, and combinations thereof. The solvent-cast film may generally have a thickness of about 1 micrometer to about 5 millimeters. Within this range, the thickness may be at least about 10 micrometers, or at least about 20 micrometers. Also within this range, the thickness may be up to about 1 millimeter, or up to about 100 micrometers.

In one embodiment, the grafted poly(arylene ether) is shaped into an article, and the article's surface is exposed to water to form a surface layer of crosslinked poly(arylene ether). Shaped articles may be prepared using thermoplastic fabrication methods known in the art, including, for example, single layer and multilayer foam extrusion, single layer and multilayer sheet extrusion, injection molding, blow molding, extrusion, film extrusion, profile extrusion, pultrusion, compression molding, thermoforming, pressure forming, hydroforming, vacuum forming, and foam molding. Combinations of the foregoing article fabrication methods may be used. Thus, the crosslinked poly(arylene ether) may be included in the surface layer of an article.

One advantage of the crosslinked poly(arylene ether) relative to uncrosslinked poly(arylene ether) resins is its increased chemical resistance. One manifestation of this increased chemical resistance is a decreased solubility in chloroform. For example, the crosslinked poly(arylene ether) may have a solubility less than or equal to 8 milligrams per milliliter in chloroform at 25° C., compared to a chloroform solubility of over 100 milligrams per milliliter for the corresponding uncrosslinked poly(arylene ether).

In one embodiment, reacting the grafted poly(arylene ether) with water is conducted in the absence of any polymer other than uncrosslinked poly(arylene ether) and grafted poly(arylene ether). For example, the reaction of the grafted poly(arylene ether) with water described herein is distinguished from known reactions in which a grafted poly(arylene ether) is used to compatibilize a blend of a poly(arylene ether) with a polyamide or a polyester. See, for example, U.S. Pat. No. 4,315,086 to Ueno et al., and U.S. Pat. No. 4,944,525 to Brown et al.

One embodiment is a crosslinked poly(arylene ether), prepared by a method, comprising: forming a grafted poly(arylene ether) by melt kneading a composition comprising an uncrosslinked poly(arylene ether) comprising a plurality of 2,6-dimethyl-1,4-phenylene ether units, vinyltriethoxysilane, and dicumyl peroxide; and reacting the grafted poly(arylene ether) with water in the presence of dibutyl tin laurate to form a crosslinked poly(arylene ether).

One embodiment is a method of preparing a crosslinked poly(arylene ether), comprising: forming a grafted poly(arylene ether) by reacting an uncrosslinked poly(arylene ether) with a crosslinking agent having the structure 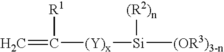
wherein R¹ is hydrogen or methyl; R² is C₁-C₈ hydrocarbyl; R³ is C₁-C₄ alkyl or C₂-C₆ alkoxyalkyl; n is 0, 1, or 2; x is 0 or 1; and Y is selected from
—R⁵—, —O—R⁵—, —C(O)—R⁵—, —C(O)—X—R⁵—, and —X—C(O)—R⁵—
wherein R⁵ is C₁-C₁₂ hydrocarbylene, and X is O, S, or NR⁶, wherein R⁶ is hydrogen or C₁-C₁₂ hydrocarbyl; and reacting the grafted poly(arylene ether) with water to form a crosslinked poly(arylene ether).

One embodiment is a method of preparing a crosslinked poly(arylene ether), comprising: forming a grafted poly(arylene ether) by melt kneading a composition comprising an uncrosslinked poly(arylene ether) comprising a plurality of 2,6-dimethyl-1,4-phenylene ether units, vinyltriethoxysilane, dicumyl peroxide, and dibutyl tin laurate; and reacting the grafted poly(arylene ether) with water to form a crosslinked poly(arylene ether).

The invention further includes a composition comprising any of the above described crosslinked poly(arylene ether) resins. In addition to a crosslinked poly(arylene ether) resin, the composition may, optionally, comprise other components. For example, the composition may comprise uncrosslinked poly(arylene ether) and/or grafted poly(arylene ether). As another example, the composition may comprise an additive selected from flame retardants, impact modifiers, plasticizers, stabilizers, colorants, adhesion promoters, processing aids, and mixtures thereof. The composition may also optionally comprise a filler such as silica (including fused silica and crystalline silica), alumina, aluminum silicate, calcium silicate, zirconium silicate, barium titanate, barium ferrite, barium sulfate, carbon black, single-wall and multi-wall carbon nanofibers, glass fibers, glass spheres, boron nitride, boron silicate, wollastonite, calcium carbonate, kaolin, talk, mica, molybdenum sulfide, zinc sulfide, and the like, and combinations thereof.

The invention also includes an article formed from the composition. The articles may comprise the crosslinked poly(arylene ether)-containing composition in various forms, including a film, a sheet, a molded object, or a composite, or any of the foregoing forms comprising at least one layer comprising the composition. For example, the crosslinked poly(arylene ether)-containing composition may be used in the fabrication of flexible integrated circuits, capacitor films, electronics packaging, and gas separation membranes.

The invention is further illustrated by the following non-limiting examples.

### EXAMPLES 1-6, COMPARATIVE EXAMPLES 1-3

These examples describe the preparation and characterization of compositions comprising silane-grafted poly(arylene ether) resins. The compositions varied in the amounts of crosslinking agent, radical initiator, and glass spheres. Compositions are presented in Table 1. All components amounts are in parts by weight. In Table 1, “0.331V PPE” is a poly(2,6-dimethyl-1,4-phenylene ether) resin having an intrinsic viscosity of about 0.33 deciliters per gram measured at 25° C. in chloroform, obtained as from General Electric Company; the crosslinking agent “Vinyltriethoxysilane” was obtained as SILQUEST® A151 from General Electric Company; the radical initiator “Dicumyl peroxide” was obtained from Acros Chemical; hollow glass spheres having a diameter of about 30 micrometers, a density of 0.6 grams/centimeter³, and a crush strength of 124 megapascals (18,000 pounds per square inch) were obtained as SCOTCHLITE® S60 glass bubbles from 3M.

Compositions containing crosslinked poly(arylene ether) were prepared as follows. The extruder was a 30-millimeter, intermeshing twin-screw extruder manufactured by Werner & Pfleiderer, having a 10-barrel configuration with a length to diameter (L/D) ratio of 32:1. Compounding conditions were as follows: temperature profile from feed throat to die, 240° C./280° C./300° C./300° C./300° C./300° C.; screw rotations per minute (RPM), 325; total feed rate, 9.07 kilograms/hour (20 pounds/hour); vacuum vent at barrel 10 at a pressure of 85 kilopascals (25 inches of mercury). Material was passed through a strand die at the end of the extruder and the extruded strands were pelletized with a rotary strand-cut pelletizer. Test articles were injection molded on a 120 Ton Van Dorn injection molding machine configured with ASTM test part molds. The temperature of the molding machine barrel was 232° C. (450° F.), and the mold temperature was 65° C. (150° F.). Physical property values are presented in Table 1. Flexural strength and flexural modulus, expressed in megapascals (MPa), were measured at 23° C. according to ISO 178. Tensile strain at break, expressed in percent (%), and tensile stress at break, expressed in MPa, were measured at 23° C. according to ISO 527. Heat deflection temperature, expressed in degrees centigrade (° C.), was measured according to ISO 75/Be. Izod notched impact strength, expressed in kilojoules per meter-squared (kJ/m²), was measured at 23° C. according to ISO 180/1A. Chord modulus, expressed in units of MPa, was measured at 25° C. according to ISO 527. Proton nuclear magnetic resonance spectroscopy (¹H NMR) was used to determine the percentage of silane crosslinking agent within the composition bound to the poly(arylene ether) (determined by integration of methylene proton peaks for the addition product of the poly(arylene ether) to the vinyl group of the vinyltriethoxysilane) and not bound to the poly(arylene ether) (determined by integration of vinyl proton peaks for the free vinyltriethoxysilane).

TABLE 1

| | Ex. 1 | Ex. 2 | Ex. 3 | Ex. 4 | Ex. 5 |
|---|---|---|---|---|---|
| COMPOSITION | | | | | |
| 0.33 IV PPE | 94.78 | 93.9 | 89.78 | 88.9 | 79.78 |
| Vinyltriethoxysilane | 0.2 | 1 | 0.2 | 1 | 0.2 |
| Dicumyl peroxide | 0.02 | 0.1 | 0.02 | 0.1 | 0.02 |
| Hollow glass spheres | 5 | 5 | 10 | 10 | 13 |
| PROPERTIES | | | | | |
| Flexural modulus (MPa) | 2733.80 | 2750.80 | 2967.80 | 2922.00 | 2963.60 |
| Flexural strength (MPa) | 119.14 | 119.18 | 121.45 | 119.37 | 119.26 |
| Tensile strain at break (%) | 0.00 | 0.00 | 8.57 | 9.15 | 6.85 |
| Tensile stress at break (MPa) | 0.00 | 0.00 | 114.07 | 109.18 | 118.00 |
| Heat deflection temp. (° C.) | 201.67 | 200.30 | 203.23 | 202.43 | 203.90 |
| Izod notched impact strength | 2.92 | 3.00 | 2.84 | 2.85 | 2.77 |
| (kJ/m²) | | | | | |
| Chord modulus (MPa) | 2807.00 | 2718.20 | 3087.80 | 3070.80 | 3175.20 |
| Bound vinyltriethoxysilane | 43 | 25 | 50 | 26 | 74 |
| (%) | | | | | |
| Unbound vinyltriethoxysilane | 15 | 18 | 21 | 16 | 21 |
| (%) | | | | | |

| | Ex. 6 | C. Ex. 1 | C. Ex. 2 | C. Ex. 3 |
|---|---|---|---|---|
| COMPOSITION | | | | |
| 0.33 IV PPE | 78.9 | 95 | 90 | 80 |
| Vinyltriethoxysilane | 1 | 0 | 0 | 0 |
| Dicumyl peroxide | 0.1 | 0 | 0 | 0 |
| Hollow glass spheres | 13 | 5 | 10 | 13 |
| PROPERTIES | | | | |
| Flexural modulus (MPa) | 2982.40 | 2714.00 | 2992.00 | 2997.00 |
| Flexural strength (MPa) | 119.96 | 118.20 | 120.01 | 117.58 |
| Tensile strain at break (%) | 0.00 | 0.00 | 6.04 | 5.76 |
| Tensile stress at break (MPa) | 0.00 | 0.00 | 119.76 | 117.46 |
| Heat deflection temp. (° C.) | 201.67 | 201.60 | 203.97 | 203.73 |
| Izod notched impact strength | 2.92 | 2.91 | 2.63 | 2.71 |
| (kJ/m²) | | | | |
| Chord modulus (MPa) | 2807.00 | 3183.40 | 3251.40 | 3432.00 |
| Bound vinyltriethoxysilane | 22 | — | — | — |
| (%) | | | | |
| Unbound vinyltriethoxysilane | 19 | — | — | — |
| (%) | | | | |

The ¹HNMR results show that 22-74 percent of the added crosslinking agent ends up grafted to the poly(arylene ether) chains. The physical property results show that the incorporation of silane graft sites onto the PPO chains does not greatly impact the physical properties of the material and that there is not a large degree of crosslinking occurring during preparation of the grafted poly(arylene ether).

### EXAMPLE 7

This example describes the preparation and characterization of a crosslinked poly(arylene ether). Silane grafted poly(arylene ether) was prepared by blending an uncrosslinked poly(arylene ether) resin with peroxide and silane. The blended samples were then added to the feed throat of a 30-millimeter extruder and extruded. The extrudate was pelletized and the pellets were dissolved in chloroform as the film casting solvent. A section of the solvent cast sheet was steam treated by placing the 0.1 gram of film sample into a 20 milliliter polytetrafluoroethylene Parr bomb along with 1 milliliter deionized water. The polytetrafluoroethylene Parr bomb was sealed and placed into a steel jacket and then placed in an oven at 200° C. for times varying from 60 to 120 minutes. Fourier transform infrared (FTIR) spectroscopy was used to monitor the decreasing intensity of a Si—O—CH₂CH₃ stretch at 1082 reciprocal centimeters (cm⁻¹) and the increasing intensity of a Si—O—Si stretch at 1041 cm⁻¹. The results show that crosslinking occurs via the formation of Si—O—Si bonds. Additional evidence for crosslinking was a dramatic improvement in solvent resistance to chloroform (the solvent from which the films were cast).

### EXAMPLES 8-16 COMPARATIVE EXAMPLES 4-8

These examples describe the preparation and characterization of silane-grafted poly(arylene ether) resins. The compositions varied in the amount of radical initiator, and type and amount of silane crosslinking agent. Compositions are presented in Table 2. The poly(arylene ether), the dicumyl peroxide initiator, and the vinyltriethoxysilane are the same as those used in Examples 1-6, above. Vinyltrimethoxysilane was obtained as SELQLEST® A-171 from General Electric Company.

Properties are given in Table 1. Weight average molecular weight (M_{w}) and number average molecular weight (Mₙ), both expressed in atomic mass units (AMU), were determined by gel permeation chromatography using polystyrene standards. The percent change in M_{w} after extrusion was determined relative to Comparative Example 4, which had no radical initiator or crosslinker. The boiling experiment was conducted by placing 2 grams of extruded pellets into a beaker containing 1 liter boiling water. The water level was maintained between 1 liter and 700 milliliters, and hot water was added as needed to compensate for evaporation. The pellets were boiled for 24 hours. The percent change in M_{w} “after boiling” was determined by gel permeation chromatography and comparing the resulting M_{w} value to that of Comparative Example 4 after extrusion but before boiling.

TABLE 2

| | C. Ex. 4 | C. Ex. 5 | C. Ex. 6 | C. Ex. 7 | C. Ex. 8 |
|---|---|---|---|---|---|
| COMPOSITION | | | | | |
| 0.33 IV PPE | 100.00 | 99.75 | 99.50 | 99.00 | 98.00 |
| Dicumyl peroxide | — | 0.25 | 0.50 | 1.00 | 2.00 |
| Vinyltriethoxysilane | — | — | — | — | — |
| Vinyltrimethoxysilane | — | — | — | — | — |
| PROPERTIES | | | | | |
| M_{w} (AMU) | 45,402 | 46,262 | 48,100 | 51,197 | 60,270 |
| Mₙ (AMU) | 16,109 | 16,125 | 16,153 | 16,276 | 16,397 |
| M_{w} change after extrusion (%) | 0 | 1.894 | 5.942 | 12.76 | 32.75 |
| M_{w} change after boiling (%) | −0.46 | 2.41 | 4.493 | 11.58 | 28.52 |

| | Ex. 8 | Ex. 9 | Ex. 10 | Ex. 11 | Ex. 12 |
|---|---|---|---|---|---|
| COMPOSITION | | | | | |
| 0.33 IV PPE | 98.00 | 97.00 | 94.00 | 97.75 | 97.50 |
| Dicumyl peroxide | 1.00 | 1.00 | 1.00 | 0.25 | 0.50 |
| Vinyltriethoxysilane | 1.00 | 2.00 | 5.00 | 2.00 | 2.00 |
| Vinyltrimethoxysilane | — | — | — | — | — |
| PROPERTIES | | | | | |
| M_{w} (AMU) | 56,327 | 61,529 | 68,716 | 52,072 | 52,168 |
| Mₙ (AMU) | 16,527 | 16,995 | 17,764 | 16,621 | 17,008 |
| M_{w} change after extrusion (%) | 24.06 | 35.52 | 51.35 | 14.69 | 14.9 |
| M_{w} change after boiling (%) | 19.68 | 31.1 | 53.09 | 13.33 | 27.99 |

| | Ex. 13 | Ex. 14 | Ex. 15 | Ex. 16 |
|---|---|---|---|---|
| COMPOSITION | | | | |
| 0.33 IV PPE | 97.00 | 98.00 | 97.00 | 88.00 |
| Dicumyl peroxide | 1.00 | 1.00 | 1.00 | 2.00 |
| Vinyltriethoxysilane | 2.00 | — | — | 10.00 |
| Vinyltrimethoxysilane | — | 1.00 | 2.00 | — |
| PROPERTIES | | | | |
| M_{w} (AMU) | 62,027 | 60,103 | 67,102 | 89,581 |
| Mₙ (AMU) | 16,995 | 16,797 | 17,667 | 18,595 |
| M_{w} change after extrusion (%) | 36.62 | 32.38 | 47.8 | 97.31 |
| M_{w} change after boiling (%) | 33.02 | 28.33 | 55.83 | 109 |

The results show that although in some cases there were small increases in M_{w} as a result of boiling, the samples were not extensively cross-linked.

### EXAMPLES 17-25, COMPARATIVE EXAMPLE 9

These examples provide further characterization of grafted and crosslinked poly(arylene ether) resins. Compositions are presented in Table 4. The procedures of Examples 1-6 were used, except that the poly(arylene ether) was dried in a shallow 30.5 centimeters by 45.7 centimeters (12 inches by 18 inches) pan in a circulating air oven at 100° C. for two hours prior to blending. Properties are presented in Table 4. Weight and number average molecular weight values were determined as described above. The average number of silane groups per poly(arylene ether) chain was calculated based on the relative intensities of ¹HNMR peaks of the methylene protons adjacent to the silicon atom of bound silane and the methyl hydrogens of phenylene ether repeat units, adjusted for number average molecular weight. Glass transition temperatures were determined by dynamic mechanical analysis (DMA) on samples that had been solvent cast and steam treated. The solubilities of the crosslinked materials were determined by placing 0.100 gram of steam-treated films in 10 milliliters of chloroform, shaking for one hour at room temperature, filtering the sample, and weighing the filtrate. In Table 4, higher values of “Percent insoluble” correspond to more highly crosslinked samples.

TABLE 4

| | C. Ex. 9 | Ex. 17 | Ex. 18 | Ex. 19 | Ex. 20 |
|---|---|---|---|---|---|
| COMPOSITION | | | | | |
| 0.33 IV PPE | 100.00 | 89.00 | 92.50 | 86.80 | 92.00 |
| Dicumyl peroxide | — | 1.00 | 0.50 | 1.20 | 1.00 |
| Vinyltriethoxysilane | — | 10.00 | 7.00 | 12.00 | 7.00 |
| PROPERTIES | | | | | |
| M_{w} (AMU) | 33,570 | 41,220 | 40,600 | 41,830 | 40,550 |
| Mₙ (AMU) | 13,100 | 15,700 | 16,450 | 16,560 | 16,240 |
| Siloxane groups per PPE chain | 0 | 2.06 | 1.59 | 2.40 | 2.12 |
| Glass transition temp. (° C.) | — | — | — | — | 205.2 |
| Percent insoluble (%) | 18.10% | 83.27% | 77.68% | 87.24% | 81.11% |
| | Ex. 21 | Ex. 22 | Ex. 23 | Ex. 24 | Ex. 25 |
| COMPOSITION | | | | | |
| 0.33 IV PPE | 89.50 | 91.80 | 88.80 | 87.00 | 87.50 |
| Dicumyl peroxide | 0.50 | 1.20 | 1.20 | 1.00 | 0.50 |
| Vinyltriethoxysilane | 10.00 | 7.00 | 10.00 | 12.00 | 12.00 |
| PROPERTIES | | | | | |
| M_{w} (AMU) | 40,200 | 40,220 | 40,730 | 41,620 | 41,290 |
| Mₙ (AMU) | 15,910 | 15,620 | 16,180 | 16,060 | 16,040 |
| Siloxane groups per PPE chain | 1.74 | 2.03 | 2.26 | 2.13 | 1.99 |
| Glass transition temp. (° C.) | — | — | 203.7 | — | 207.8 |
| Percent insoluble (%) | 75.80% | 81.79% | 85.98% | 83.15% | 74.85% |

The results show that extrusion with silanes and subsequent film casting and steam treatment greatly increased the chemical resistance (due to cross-linking). So much so that GPC analysis became impossible via conventional means because the film samples were largely insoluble in the mobile phase. The glass transition temperature (T_{g}) increase is not particularly significant, but a slight increase of about 5-10° C. was observed for steam treated samples.

### EXAMPLE 26

This example illustrates catalyzed crosslinking of film samples of grafted poly(arylene ether). Viscous samples were made up by dissolving 5 grams silane-grafted poly(2,6-dimethyl-1,4-phenylene ether) pellets in 15-20 milliliters chloroform. The crosslinking catalyst dibutyl tin laurate was added to the viscous poly(arylene ether) solution in amounts varying from 10 to 1000 parts per million by weight based on grafted poly(arylene ether), and the solutions were mixed. Films were then cast onto a glass plate and chloroform was allowed to evaporate at room temperature for 20 minutes. The films were then peeled from the glass plates and placed in a vacuum oven at 80° C. and a vacuum of about 34-102 kilopascals (about 10 to 30 inches of mercury) to remove residual chloroform, and then for one hour at 220° C. and one atmosphere of air to promote crosslinking.

### EXAMPLES 27-30

These examples illustrate one manifestation of the improved heat resistance of the crosslinked poly(arylene ether): resistance to molten solder. Solvent-cast, crosslinked films were by forming grafted poly(arylene ether) resins, solvent casting films from the grafted poly(arylene ether) resins, then exposing the films to water to crosslink the poly(arylene ether) resins. Grafted poly(arylene ether) resins generally were prepared according to the method of Examples 17-25 using 95 parts by weight poly(2,6-dimethyl-1,4-phenylene ether), 1 part by weight dicumyl peroxide, and 4 parts by weight vinyl triethoxysilane. Films of the grafted poly(arylene ether) were cast out of chloroform and crosslinked according to the method of Example 26. Each crosslinked film had a thickness of about 25 micrometers. The samples vary according to the proportions of poly(arylene ether) (PPE), silane crosslinking agent, and dicumyl peroxide (DCP) initiator, as well as the type of silane crosslinking agent used. Example 27 was prepared by solvent casting a film prepared from 94 weight percent poly(2,6-dimethyl-1,4-phenylene ether), 5 weight percent vinyltriethoxysilane, and 1 weight percent dicumyl peroxide. Example 28 was prepared by solvent casting a film prepared from 96.4 weight percent poly(2,6-dimethyl-1,4-phenylene ether), 3 weight percent vinyltriethoxysilane, and 0.6 weight percent dicumyl peroxide. Example 29 was prepared by solvent casting a film prepared from 94 weight percent poly(2,6-dimethyl-1,4-phenylene ether), 5 weight percent methacryloxypropyltriethoxysilane, and 1 weight percent dicumyl peroxide. Example 30 was prepared by solvent casting a film prepared from 98.8 weight percent poly(2,6-dimethyl-1,4-phenylene ether), 1 weight percent methacryloxypropyltriethoxysilane, and 0.2 weight percent dicumyl peroxide.

The solder float test is described in IPC-TM-650, method 2.4.13 Rev. F. Specimens were attached to the solder float test fixture and floated, foil side down just beneath the surface of molten solder maintained at 288±5° C. for one hour. After solder immersion, each sample was thoroughly cleaned and examined with 10× magnification for blistering, shrinkage, distortion or melting. Samples passed the test if they exhibited no blistering, shrinkage, distortion, or melting. Results are summarized in Table 5. The results show that the crosslinked poly(arylene ether) resins are robust to exposure to molten solder at temperatures as great as 288° C.

TABLE 5

| Ex. No. | Sample Description | Test Result |
|---|---|---|
| 27 | 94% PPE, 5% vinyl silane, 1% DCP film | Passed |
| 28 | 96.4% PPE, 3% vinyl silane, 0.6% DCP film | Passed |
| 29 | 94% PPE, 5% methacryl silane, 1% DCP film | Passed |
| 30 | 98.8% PPE, 1% methacryl silane, 0.2% DCP film | Passed |

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

All cited patents, patent applications, and other references are incorporated herein by reference in their entirety.

All ranges disclosed herein are inclusive of the endpoints, and the endpoints are combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another.

1. A crosslinked poly(arylene ether), comprising a crosslink unit having the structure 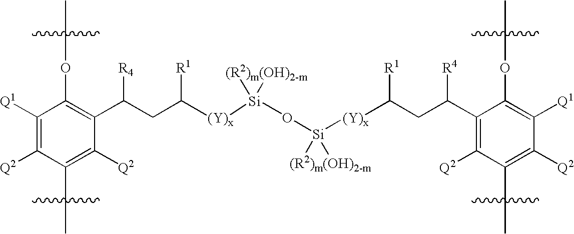
wherein each occurrence of R¹ is independently hydrogen or methyl; each occurrence of R² is independently C₁-C₈ hydrocarbyl; each occurrence of m is independently 0, 1, or 2; each occurrence of R⁴ is independently hydrogen or C₁-C₁₁ hydrocarbyl; each occurrence of Q¹ is independently halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms; each occurrence of Q² is independently hydrogen, halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms; each occurrence of x is independently 0 or 1; and each occurrence of Y is independently selected from
—R⁵—, —O—R⁵—, —C(O)—R⁵—, —C(O)—X—R⁵—, and —X—C(O)—R⁵—
wherein R⁵ is C₁-C₁₂ hydrocarbylene, and X is O, S, or NR⁶, wherein R⁶ is hydrogen or C₁-C₁₂ hydrocarbyl.

2. The crosslinked poly(arylene ether) of claim 1, wherein each occurrence of Q¹ is independently halogen or C₁-C₁I₁ alkyl; and each occurrence of Q² is independently hydrogen, halogen, or C₁-C₁₁ alkyl.

3. The crosslinked poly(arylene ether) of claim 1, wherein each occurrence of R⁴ is hydrogen, each occurrence of Q¹ is methyl, and each occurrence of Q² is independently hydrogen or methyl.

4. The crosslinked poly(arylene ether) of claim 1, wherein each occurrence of R¹ is hydrogen, and each occurrence of m and x is zero.

5. The crosslinked poly(arylene ether) of claim 1, further comprising a plurality of uncrosslinked units having the structure 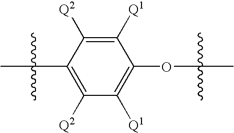
wherein each occurrence of Q¹ is independently halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms; and each occurrence of Q² is independently hydrogen, halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms.

6. A crosslinked poly(arylene ether), comprising a crosslink unit having the structure 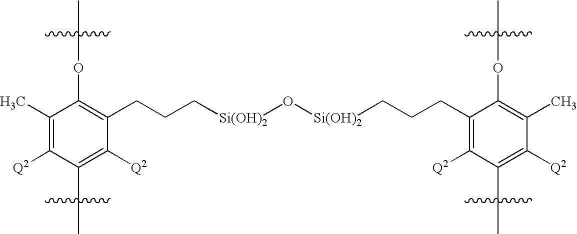
wherein each occurrence of Q² is independently hydrogen or methyl.

7. The crosslinked poly(arylene ether) of claim 5, wherein each Q² is hydrogen.

8. A crosslinked poly(arylene ether), prepared by a method, comprising:
forming a grafted poly(arylene ether) by reacting an uncrosslinked poly(arylene ether) with a crosslinking agent having the structure 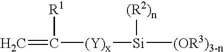
wherein R¹ is hydrogen or methyl; R² is C₁-C₈ hydrocarbyl; R³ is C₁-C₄ alkyl or C₂-C₆ alkoxyalkyl; n is 0, 1, or 2; x is 0 or 1; and Y is selected from
—R⁵—, —O—R⁵—, —C(O)—R⁵—, —C(O)—X—R⁵—, and —X—C(O)—R⁵—
wherein R⁵ is C₁-C₁₂ hydrocarbylene, and X is O, S, or NR⁶, wherein R⁶ is hydrogen or C₁-C₁₂ hydrocarbyl; and
reacting the grafted poly(arylene ether) with water to form a crosslinked poly(arylene ether).

9. The crosslinked poly(arylene ether) of claim 8, wherein the uncrosslinked poly(arylene ether) comprises a plurality of repeating units having the structure 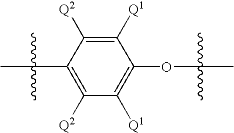
wherein each occurrence of Q¹ is independently halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms; and each occurrence of Q² is independently hydrogen, halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms.

10. The crosslinked poly(arylene ether) of claim 9, wherein each occurrence of Q¹ is independently halogen or C₁-C₁₁ alkyl; and each occurrence of Q² is independently hydrogen, halogen, or C₁-C₁₁ alkyl.

11. The crosslinked poly(arylene ether) of claim 9, wherein each occurrence of Q¹ is methyl; and each occurrence of Q² is independently hydrogen or methyl.

12. The crosslinked poly(arylene ether) of claim 8, wherein the uncrosslinked poly(arylene ether) has an intrinsic viscosity of about 0.06 to about 0.6 deciliters per gram at 25° C. in chloroform.

13. The crosslinked poly(arylene ether) of claim 8, wherein x and n are zero, and R¹ is hydrogen.

14. The crosslinked poly(arylene ether) of claim 8, wherein x and n are zero; R¹ is hydrogen; and R³ is ethyl.

15. The crosslinked poly(arylene ether) of claim 8, wherein x is 1; Y is —C(O)—X—R⁵— wherein X is 0 and R⁵ is trimethylene; n is zero; R¹ is hydrogen; and R³ is ethyl.

16. The crosslinked poly(arylene ether) of claim 8, wherein said reacting an uncrosslinked poly(arylene ether) with a crosslinking agent comprises reacting about 0.05 to about 20 parts by weight of the crosslinking agent per 100 parts by weight of the uncrosslinked poly(arylene ether).

17. The crosslinked poly(arylene ether) of claim 8, wherein said reacting an uncrosslinked poly(arylene ether) with a crosslinking agent comprises melt kneading the uncrosslinked poly(arylene ether) and the crosslinking agent.

18. The crosslinked poly(arylene ether) of claim 8, wherein said reacting an uncrosslinked poly(arylene ether) with a crosslinking agent is conducted in the presence of a radical initiator.

19. The crosslinked poly(arylene ether) of claim 8, wherein said reacting the grafted poly(arylene ether) with water comprises treating the grafted poly(arylene ether) with water at a temperature of about 85 to about 275° C.

20. The crosslinked poly(arylene ether) of claim 8, wherein said reacting the grafted poly(arylene ether) with water comprises exposing the grafted poly(arylene ether) to atmospheric moisture.

21. The crosslinked poly(arylene ether) of claim 8, wherein said reacting the grafted poly(arylene ether) with water is conducted in the presence of a catalyst selected from dibutyl tin dilaurate, dibutyl tin diacetate, dibutyl tin laurate acetate, dibutyl tin dioctoate, dioctyl tin dilaurate, dioctyl tin dioctoate, bis(2-ethylhexanoate)tin, bis(neodecanoate)tin, stannous octoate, stannous acetate, dibutyl tin bis(acetylacetonate), lead naphthenate, cobalt naphthenate, zinc octoate, tetrabutyl titanate, tetranonyl titanate, bis(acetylacetonate)dipropyltitanate, and combinations thereof.

22. The crosslinked poly(arylene ether) of claim 8, wherein said method further comprises sheet extruding the grafted poly(arylene ether).

23. The crosslinked poly(arylene ether) of claim 8, wherein said method further comprises solvent casting the grafted poly(arylene ether).

24. The crosslinked poly(arylene ether) of claim 8, wherein said method further comprises forming an article comprising the grafted poly(arylene ether); and wherein said reacting the grafted poly(arylene ether) with water comprises exposing the surface of the article to water.

25. The crosslinked poly(arylene ether) of claim 8, wherein the grafted poly(arylene ether) comprises about 0.1 to about 2.5 silyl grafts per poly(arylene ether) chain.

26. The crosslinked poly(arylene ether) of claim 8, having a solubility less than or equal to 8 milligrams per milliliter in chloroform at 25° C.

27. The crosslinked poly(arylene ether) of claim 8, wherein said reacting the grafted poly(arylene ether) with water is conducted in the absence of a polymer other than the uncrosslinked poly(arylene ether) and the grafted poly(arylene ether).

28. A crosslinked poly(arylene ether), prepared by a method, comprising:
forming a grafted poly(arylene ether) by melt kneading a composition comprising
an uncrosslinked poly(arylene ether) comprising a plurality of 2,6-dimethyl-1,4-phenylene ether units,
vinyltriethoxysilane, and
dicumyl peroxide; and
reacting the grafted poly(arylene ether) with water in the presence of dibutyl tin laurate at a temperature of about 85 to about 275° C. to form a crosslinked poly(arylene ether).

29. A method of preparing a crosslinked poly(arylene ether), comprising:
forming a grafted poly(arylene ether) by reacting an uncrosslinked poly(arylene ether) with a crosslinking agent having the structure 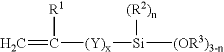
wherein R¹ is hydrogen or methyl; R² is C₁-C₈ hydrocarbyl; R³ is C₁-C₄ alkyl or C₂-C₆ alkoxyalkyl; n is 0, 1, or 2; x is 0 or 1; and Y is selected from
—R⁵—, —O—R⁵—, —C(O)—R⁵—, —C(O)—X—R⁵—, and —X—C(O)—R⁵—
wherein R⁵ is C₁-C₁₂ hydrocarbylene, and X is O, S, or NR⁶, wherein R⁶ is hydrogen or C₁-C₁₂ hydrocarbyl; and
reacting the grafted poly(arylene ether) with water to form a crosslinked poly(arylene ether).

30. A method of preparing a crosslinked poly(arylene ether), comprising:
forming a grafted poly(arylene ether) by melt kneading a composition comprising
an uncrosslinked poly(arylene ether) comprising a plurality of 2,6-dimethyl-1,4-phenylene ether units,
vinyltriethoxysilane, and
dicumyl peroxide; and
reacting the grafted poly(arylene ether) with water in the presence of dibutyl tin laurate to form a crosslinked poly(arylene ether).

31. A composition comprising the crosslinked poly(arylene ether) of claim 1.

32. The composition of claim 31, further comprising an uncrosslinked poly(arylene ether).

33. The composition of claim 31, further comprising an additive selected from flame retardants, impact modifiers, plasticizers, stabilizers, colorants, adhesion promoters, processing aids, and mixtures thereof.

34. The composition of claim 31, further comprising a filler selected from silica (including fused silica and crystalline silica), alumina, aluminum silicate, calcium silicate, zirconium silicate, barium titanate, barium ferrite, barium sulfate, carbon black, single-wall and multi-wall carbon nanofibers, glass fibers, glass spheres, boron nitride, boron silicate, wollastonite, calcium carbonate, kaolin, talk, mica, molybdenum sulfide, zinc sulfide, and combinations thereof.

35. An article comprising the composition of claim 31.

36. A composition comprising the crosslinked poly(arylene ether) of claim 8.

37. The composition of claim 36, further comprising an additive selected from flame retardants, impact modifiers, plasticizers, stabilizers, colorants, adhesion promoters, processing aids, and mixtures thereof.

38. The composition of claim 36, further comprising a filler selected from silica (including fused silica and crystalline silica), alumina, aluminum silicate, calcium silicate, zirconium silicate, barium titanate, barium ferrite, barium sulfate, carbon black, single-wall and multi-wall carbon nanofibers, glass fibers, glass spheres, boron nitride, boron silicate, wollastonite, calcium carbonate, kaolin, talk, mica, molybdenum sulfide, zinc sulfide, and combinations thereof.

39. An article comprising the composition of claim 36.

40. A film comprising the composition of claim 36.
